(19) United States
(12) Patent Application Publication
(10) Pub. No.: US 2025/0078068 A1
(43) Pub. Date: Mar. 6, 2025

(54) SYSTEM FOR RESOURCE EXCHANGE EVENT AUTHORIZATION USING A CARDED RESOURCE EXCHANGE DEVICE IMPRINTED WITH A NON-FUNGIBLE TOKEN

(71) Applicant: BANK OF AMERICA CORPORATION, Charlotte, NC (US)

(72) Inventors: Sivakumar Bogu, Hyderabad (IN); Chinmay S. Barhale, Hyderabad (IN); Deepak Gujaba Gaikwad, Singapore (SG); Debraj Goswami, Hyderabad (IN); Satyasai Veera Venkata Gudimetla, Hyderabad (IN); Kiran Pulla, Hyderabad (IN)

(73) Assignee: BANK OF AMERICA CORPORATION, Charlotte, NC (US)

(21) Appl. No.: 18/241,464

(22) Filed: Sep. 1, 2023

(51) Int. Cl. G06Q 20/38; G06Q 20/34; G06Q 20/40

(52) U.S. Cl. CPC G06Q 20/3825; G06Q 20/34; G06Q 20/401

(57) ABSTRACT

Validation/authentication of a resource exchange device and/or authorization of a resource exchange event being conducted with the resource exchange device is made possible through use of a Non-Fungible Token (NFT) that is accessible via an NFT identifier encrypted and embedded within a digital image imprinted on the resource exchange device. The NFT identifier NFT identifier may be segmented and each segmented stored in different predetermined pixels of the digital image to add an additional security layer to the validation/authorization process.

### FIELD OF THE INVENTION

The present invention is related generally to resource exchange event authorization and, more specifically, providing resource exchange authorization through use of a resource exchange device having a Non-Fungible Token (NFT) identifier embedded within a digital image imprinted on the card.

### BACKGROUND

Conventionally, resource exchange devices have been affixed with magnetic stripes that stored static data, such as user identifying data and resource exchange depository identifying data. However, magnetic stripes pose various security concerns. First, the static data stored within magnetic stripes can easily be copied or “skimmed”. In this regard, so-called “skimming devices” can be discreetly installed on resource exchange event terminals to capture data when the magnetic stripe is swiped. Such skimming makes it relatively easy for wrongdoers to obtain card information and, subsequently, clone the magnetic strip/card. In addition, magnetic strips do not have built-in encryption mechanisms to protect the date stored thereon. Such lack of encryption makes the data susceptible to nefarious interception and unauthorized access during data transmission and storage. Moreover, magnetic stripes provide limited means of verifying the authenticity of the card. In this regard, magnetic striped cards rely primarily on visual inspection of the card, which can easily be circumvented by wrongdoers in possession of forged cards.

To address these security concerns, many resource exchange device-issuing entities have transitioned to more secure technologies, such as embedding microprocessor chips within the cards. Such microprocessor chips, such as EMV chips or the like, provide stronger security through dynamic encryption and authentication mechanisms. Moreover, these microprocessor chips generate dynamic resource exchange event codes for each resource exchange event, making it more challenging for wrongdoers to clone or forge the resource exchange devices.

However, even cards with embedded microprocessor chips are susceptible to card skimming. In this regard, skimmers inserted in resource exchange event terminals are able to read the data from microprocessor chips and, subsequently, wrongdoers in possession of the data produce magnetic strip cards and use these cloned magnetic strip cards to conduct unauthorized/illicit resource exchange events.

Therefore, a need exists to develop systems, methods, computer program products that provide for alternative means for validating the authenticity of a resource exchange device and/or authorizing resource exchange events conducted through use of resource exchange devices.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing for a systems, devices and methods that validates a resource exchange device and/or authorizes a resource exchange event being conducted with the resource exchange device through use of a Non-Fungible Token (NFT) that is accessible via an NFT identifier encrypted and embedded within a digital image imprinted on the resource exchange device.

The digital image in which the NFT identifier is embedded may be the background image and/or logo imprinted on the resource exchange device or any other image or portion of an image imprinted on either facing of card-shaped resource exchange device.

In specific embodiments of the invention different segments of the NFT identifier are stored in different predetermined pixels of the digital image as a means of further obfuscating the NFT identifier.

Once the resource exchange device is presented at a corresponding reader apparatus, the digital image is scanned to read the data stored within the digital image, decrypt the data and extract the NFT identifier from the data. In those embodiments in which the NFT identifier is segmented and stored in preselected pixels, the extraction process entails determining which pixels store the segments of the NFT identifier and the sequence/order of the segments required to form the NFT identifier. Once the NFT identifier has been extracted, the corresponding distributed trust computing network, which stores the NFT, is accessed for purposes of validating the authenticity of the NFT (i.e., the resource exchange device) and authorizing the resource exchange event.

In specific embodiments of the invention, the resource exchange device is also equipped with an embedded microprocessor chip that stores user-identifying data and resource exchange repository-identifying data. In specific embodiments of the invention, once the resource exchange device is presented at a corresponding reader apparatus, the data stored on the microprocessor chip is also read and communicated to a backend resource exchange device-issuing entity for authorization of the resource exchange event. In such embodiments both the authorization provided for by the NFT and the authorization provided for by the data stored on the microprocessor chip are required to confirm the resource exchange event. In other specific embodiments of the invention, the authorization provided for by the data stored on the microprocessor chip is back-up authorization only called upon in the event that the scanner is unable to read the NFT identifier stored in the digital image.

Thus, the present invention provides heightened security to resource exchange event authorization through use of NFTs that benefit from known authenticity and traceability as exhibited by Distributed Ledger Technology (DLT). Moreover, since embodiments of the invention provide for the NFT identifier to not only be hidden within digital images and encrypted, but also obfuscated by segmenting the NFT identifier in storing the segments in different pixels, the present invention guards against the likelihood of the NFT identifier being skimmed. As a result, use of the such NFT-based authorization provides security beyond that which is afforded to conventional resource exchange device technology, such as magnetic stripes and embedded microprocessor chips.

A system for resource exchange event authorization, defines first embodiments of the invention. The system includes a resource exchange device configured in a form of a card having two facings, wherein at least one facing has a digital image imprinted thereon. The digital image includes a plurality of pixels and a Non-Fungible Token (NFT) identifier that identifies an NFT is embedded as encrypted data within one or more of the plurality of pixels. The system additionally includes a resource exchange device reader apparatus having a memory and one or more computing processor devices in communication with the memory. The memory stores a first resource exchange event authorization application the is executable by at least one of the computing device processors. The resource exchange event authorization application and is configured to, in response to a user presenting the resource exchange device at the resource exchange device reader to initiate a resource exchange event, scan the digital image to read data stored in the plurality of pixels. The reading of the data includes decrypting the encrypting data and extracting the NFT identifier from the decrypted data. Subsequently, the resource exchange event authorization application is configured to use the NFT identifier as a pointer to access the distributed trust computing network on which the NFT is stored as a means for validating the NFT (i.e., the authenticity of the resource exchange device) and providing authorization for the resource exchange event.

In specific embodiments of the system, the digital image in which the NFT identifier is embedded is a background image imprinted on the at least one facing of the card, and/or a logo image imprinted on the at least one facing of the card.

In other specific embodiments of the system, individual segments of the NFT identifier are embedded in two or more first pixels from amongst the plurality of pixels, such that segments, when properly combined/arranged, form an entirety of the NFT identifier. In such embodiments of the system, the resource exchange event authorization application is further configured to extract the NFT identifier by determining which of the plurality of pixels are the selected first pixels having embedded segments of the NFT identifier and a sequence/order in which the segments of the NFT identifier are to be configured to form the NFT identifier. In related embodiments of the invention, fake data that resembles segments of the NFT identifier is embedded in second pixels that are different than the first pixels (e.g., the pixels if the digital image that do not store segments of the NFT identifier).

In further specific embodiments of the system, the resource exchange device further comprises an embedded microprocessor chip. In such embodiments of the system, the memory of the resource exchange device reader further stores a second resource exchange event authorization application that is configured to, in response to the user presenting the resource exchange device at the resource exchange device reader to initiate the resource exchange event, read data stored on the embedded microprocessor chip and communicate at least a portion of the data to a resource exchange event authorization entity configured to validate the portion of the data and provide second authorization for the resource exchange event. In such embodiments of the invention both the first authorization and the second authorization are required to finalize/confirm the resource exchange event (i.e., dual authorization).

In other embodiments of the invention, in which the first resource exchange event authorization application is unable to scan and/or read data from the pixels of the digital image, the second resource exchange event authorization application is configured to, in response to receiving notification that data stored in the pixels is unable to be scanned/read, read data stored on the embedded microprocessor chip and communicate at least a portion of the data to a resource exchange event authorization entity configured to validate the portion of the data and provide second authorization for the resource exchange event. In other words, the microprocessor chip data serves as a means for back-up resource exchange event authorization in the event that the NFT-related resource event authorization is unable to be performed (i.e., NFT-identifier is unable to be read).

In still further specific embodiments of the invention, in which the resource exchange device includes an embedded microprocessor chip, the chip does not store any user identifying data or resource exchange depository identifying data.

A device for resource exchange event authorization defines second embodiments of the invention. The device includes a body formed of a card having two facings. A digital image is imprinted on at least one of the facings and includes a plurality of pixels. A Non-Fungible Token (NFT) identifier that identifies an NFT is embedded as encrypted data within one or more of the plurality of pixels. The NFT identifier is configured to provide access (i.e., act as a pointer) to a distributed trust computing network storing the NFT for validating the NFT (i.e., authenticating the resource exchange device) and providing first authorization for a resource exchange event.

In specific embodiments of the device, the digital image in which the NFT-identifier is embedded is (i) a background image imprinted on the at least one facing of the card, and/or (ii) a logo image imprinted on the at least one facing of the card.

In other specific embodiments of the device, segments of the NFT identifier are embedded within two or more first pixels from amongst the plurality of pixels. The segments are configured to be arranged in predetermined order/sequence to form an entirety of the NFT identifier. In related embodiments of the device, fake data configured to resemble a segment of the NFT identifier is embedded within one or more second pixels from amongst the plurality of pixels. The second pixels are different than the first pixels (i.e., pixels that do not to store segments of the NFT-identifier).

In other embodiments the device further includes a microprocessor chip embedded within the body. The microprocessor chip stores data that is configured to be validated by a resource exchange event authorization entity to provide second authorization for the resource exchange event. In specific embodiments of the device, both the first authorization and the second authorization are required to finalize/confirm the resource exchange event. While in other embodiments of the invention, the second authorization is called upon in the event that the first authorization process was unable to be performed (i.e., unable to scan/read the NFT identifier from the digital image).

A computer-implemented method for authorizing a resource exchange event defines third embodiments of the invention. The method is executable by one or more computing device processors. The method includes generating a resource exchange device having a Non-Fungible Token (NFT) identifier, which identifies an NFT, embedded as encrypted data within one or more of a plurality of pixels that form forming a digital image imprinted on a facing of the resource exchange device.

In response to a user presenting the resource exchange device at a resource exchange device reader to initiate a resource exchange event, the method further includes scanning the digital image to read data stored in the plurality of pixels. Reading the data includes decrypting the encrypting data and extracting the NFT identifier. Further, the method includes using the NFT identifier to access a distributed trust computing that stores the NFT to validate the NFT (i.e., authenticate the resource exchange device) and provide first authorization for the resource exchange event.

In specific embodiments of the computer-implemented method, generating the resource exchange device further includes embedding segments of the NFT identifier in two or more pixels from amongst the plurality of pixels. The segments are configured to, when arranged in a predetermined sequence/order, form an entirety of the NFT identifier. In related embodiments of the computer-implemented method, extracting the NFT identifier further includes determining which of the plurality of pixels are the selected first pixels having embedded segments of the NFT identifier and/or determining a sequence in which the segments of the NFT identifier are to be configured to form the NFT identifier.

Moreover, in additional specific embodiments of the computer-implemented method, generating the resource exchange device further includes generating the resource exchange device having a microprocessor chip embedded therein. In such embodiments, the method further includes, in response to the user presenting the resource exchange device at the resource exchange device reader to initiate the resource exchange event, reading data stored on the embedded microprocessor chip and communicate at least a portion of the data to a resource exchange event authorization entity configured to validate the portion of the data and provide second authorization for the resource exchange event. In such embodiments of the computer-implemented method, both the first authorization and the second authorization may be required to finalize the resource exchange event or the second authorization may be called upon in the event that that the first authorization process is unable to be performed (i.e., NFT identifier I unable to be to read).

Thus, according to embodiments of the invention, which will be discussed in greater detail below, the present invention provides for validation of a resource exchange device and/or authorization of a resource exchange event being conducted with the resource exchange device through use of a Non-Fungible Token (NFT) that is accessible via an NFT identifier encrypted and embedded within a digital image imprinted on the resource exchange device. In specific embodiments of the invention different segments of the NFT identifier are stored in different predetermined pixels of the digital image as a means of further obfuscating the NFT identifier. Once the resource exchange device is presented at a corresponding reader apparatus, the digital image is scanned to read the data stored within the digital image, decrypt the data and extract the NFT identifier from the data. In those embodiments in which the NFT identifier is segmented and stored in preselected pixels, the extraction process entails determining which pixels store the segments of the NFT identifier and the sequence/order of the segments required to form the NFT identifier. Once the NFT identifier has been extracted, the corresponding distributed trust computing network, which stores the NFT, is accessed for purposes of validating the authenticity of the NFT (i.e., the resource exchange device) and authorizing the resource exchange event.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block diagram of a system for authorizing a resource exchange event using an NFT identifier embedded in a digital image imprinted on a resource exchange device, in accordance with embodiments of the present invention;

FIG. 2 is schematic diagram of a resource exchange device having an NFT identifier embedded in the pixels of a digital image imprinted on the device; in accordance with embodiments of the present invention;

FIG. 3 is a block diagram of a resource exchange device reader apparatus configured for reading data including an NFT identifier embedded in the pixels of a digital image imprinted on a resource exchange device, in accordance with embodiments of the present invention;

FIG. 4 is a flow diagram of a method for resource exchange event authorization based on NFT validity, in accordance with embodiments of the present invention;

FIG. 5 is flow diagram of a method for resource exchange event authorization based on NFT validity and data stored on a microprocessor chip embedded within a resource exchange device, in accordance with embodiments of the present invention;

FIG. 6 is flow diagram of a method for resource exchange event authorization based on NFT validity and, if the NFT identifier cannot be properly read, based on data stored in microprocessor chip embed on a resource exchange device, in accordance with embodiments of the present invention; and

FIG. 7 is a flow diagram of a method for resource exchange event authorization, in accordance with embodiments of the present invention

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

As the term is used herein, “resources” includes anything that may be exchanged, including, but not limited to, financial properties, such as currency, goods, services or the like.

As the phrase is used herein “resource exchange event” is any event that involves the exchange of resources. For example, a resource exchange event may include any financial transaction, including but not limited to, a purchase transaction, a deposit or withdrawal transaction or the like.

As the phrase is used herein, “resource exchange device” refers to any device used to initiate processing of a resource exchange event. In this regard, “resource exchange device” may include a credit card, a debit card, credit/debit card or any other carded device configured for initiating a transaction.

As the phrase is used herein, “distributed trust computing network” refers to a network of decentralized computing devices, referred to as nodes, which work as a consensus mechanism to verify and authenticate data and add the data as blocks to a distributed ledger stored within the network. One example of a distributed trust computing network is a blockchain network.

Thus, according to embodiments of the invention, which will be described in more detail below, systems, methods and computer program products are disclosed that providing for validation of a resource exchange device and/or authorization of a resource exchange event being conducted with the resource exchange device through use of a Non-Fungible Token (NFT) that is accessible via an NFT identifier encrypted and embedded within a digital image imprinted on the resource exchange device.

The digital image in which the NFT identifier is embedded may be the background image and/or logo imprinted on the resource exchange device or any other image or portion of an image imprinted on either facing of card-shaped resource exchange device.

In specific embodiments of the invention different segments of the NFT identifier are stored in different predetermined pixels of the digital image as a means of further obfuscating the NFT identifier.

Once the resource exchange device is presented at a corresponding reader apparatus, the digital image is scanned to read the data stored within the digital image, decrypt the data and extract the NFT identifier from the data. In those embodiments in which the NFT identifier is segmented and stored in preselected pixels, the extraction process entails determining which pixels store the segments of the NFT identifier and the sequence/order of the segments required to form the NFT identifier. Once the NFT identifier has been extracted, the corresponding distributed trust computing network, which stores the NFT, is accessed for purposes of validating the authenticity of the NFT (i.e., the resource exchange device) and authorizing the resource exchange event.

In specific embodiments of the invention, the resource exchange device is also equipped with an embedded microprocessor chip that stores user-identifying data and resource exchange repository-identifying data. In specific embodiments of the invention, once the resource exchange device is presented at a corresponding reader apparatus, the data stored on the microprocessor chip is also read and communicated to a backend resource exchange device-issuing entity for authorization of the resource exchange event. In such embodiments both the authorization provided for by the NFT and the authorization provided for by the data stored on the microprocessor chip are required to confirm the resource exchange event. In other specific embodiments of the invention, the authorization provided for by the data stored on the microprocessor chip is back-up authorization only called upon in the event that the scanner is unable to read the NFT identifier stored in the digital image.

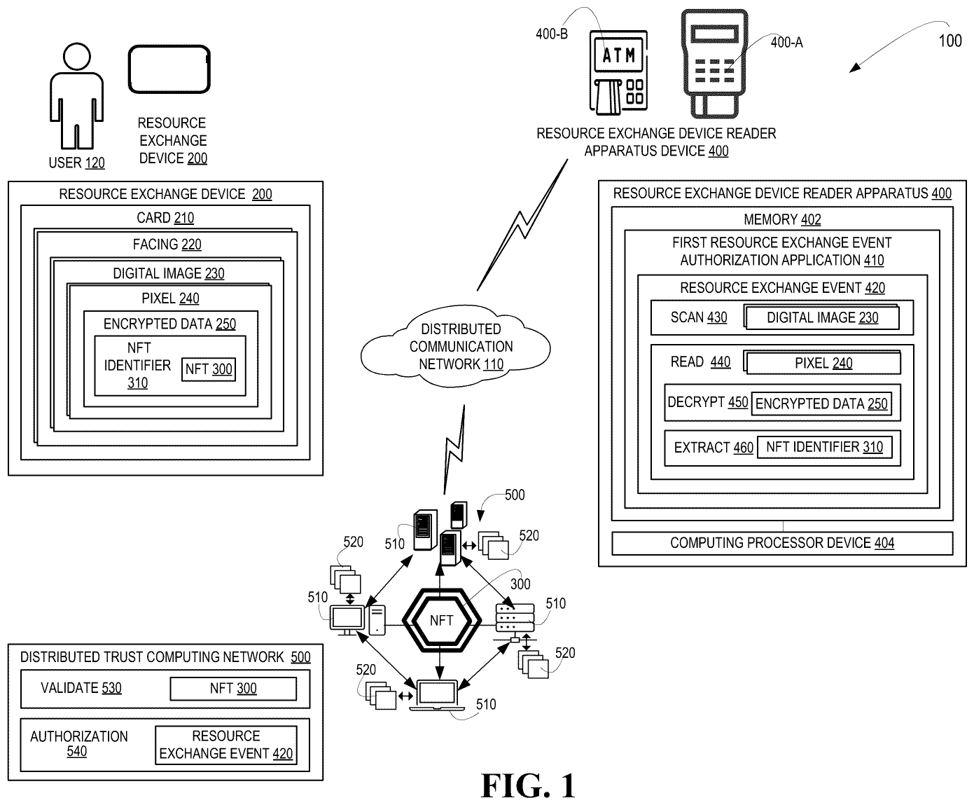

Referring to FIG. 1, a schematic/block diagram is presented of a system 100 for resource exchange event authorization, in accordance with embodiments of the invention. The system 100 is implemented in conjunction with a distributed communication network 110 that may include the Internet, one or more intranets, one or more cellular networks or the like. System 100 includes resource exchange device 200, which is in possession of user 120. Resource exchange device 300 is in the form of a card 210 having two facings 220 (typically referred to as front facing and back facing). At least one of the facings 220 includes one or more digital images 230 imprinted on the corresponding facing 220. In specific embodiments of the system, digital image 230 may be a background image covering the entirety of the facing 220 and/or a logo image positioned anywhere on a facing 220.

Digital image(s) 230 include a plurality of pixels 240, which are the smallest addressable element in the digital image 230. A Non-Fungible Token (NFT) 310 identifier that identifies (i.e., acts as a pointer to) a NFT 300 is embedded as encrypted data within one or more of the pixels 240. NFT identifier 310 is a long string of characters that acts as a pointer to the NFT, which is stored on a distributed trust computing network 500. The NFT identifier 310 may be stored in one specific pixel 240 or, in preferred embodiments, the NFT identifier 310 may be segmented, with each segment of the NFT identifier 310 stored in a corresponding pixel 240.

System 100 additionally includes a resource exchange device reader apparatus 400, which may include a Point-of-Sale (POS) terminal 400-A, an Automated Teller Machine 400-B and the like. In addition to device which scans/reads from the resource exchange device 200, reader apparatus 400 may include backend network devices (e.g., application servers) (not shown in FIG. 1) accessible via distributed trust communication network 110. Resource exchange device reader apparatus 400 includes memory 402 and one or more computing processor devices 404 in communication with memory 404. Memory 404 stores first resource exchange authorization application 410 that is executable by at least one of the computing device processors 404.

In response to user 120 presenting (i.e., inserting, tapping or the like) resource exchange device 200 at the resource exchange device reader apparatus 400 for initiating a resource exchange event 420, first resource exchange event authorization application 410 is configured to scan 430 the digital image(s) 230 to read 440 data stored in the plurality of pixels 240. Reading 440 the data includes applying requisite decryption algorithms to decrypt 450 the encrypted data 250 and extracting 460 the NFT identifier 310. In response to extracting NFT identifier 310, first resource exchange event authorization application 410 is configured to use the NFT identifier 310 to access the distributed trust computing network 500, which stores the NFT 300. Distributed trust computing network 500, commonly referred to as “block chain” network, includes a plurality of nodes 510 which store one or more distributed ledgers 520. According to embodiments of the present invention, each distributed ledger 520 stores within data blocks a corresponding NFT 300 and resource exchange event data. Once distributed trust computing network 300 is accessed, the NFT 300 is validated 530 and, in some embodiments of the system, authorization 540 is provided for the resource exchange event 420.

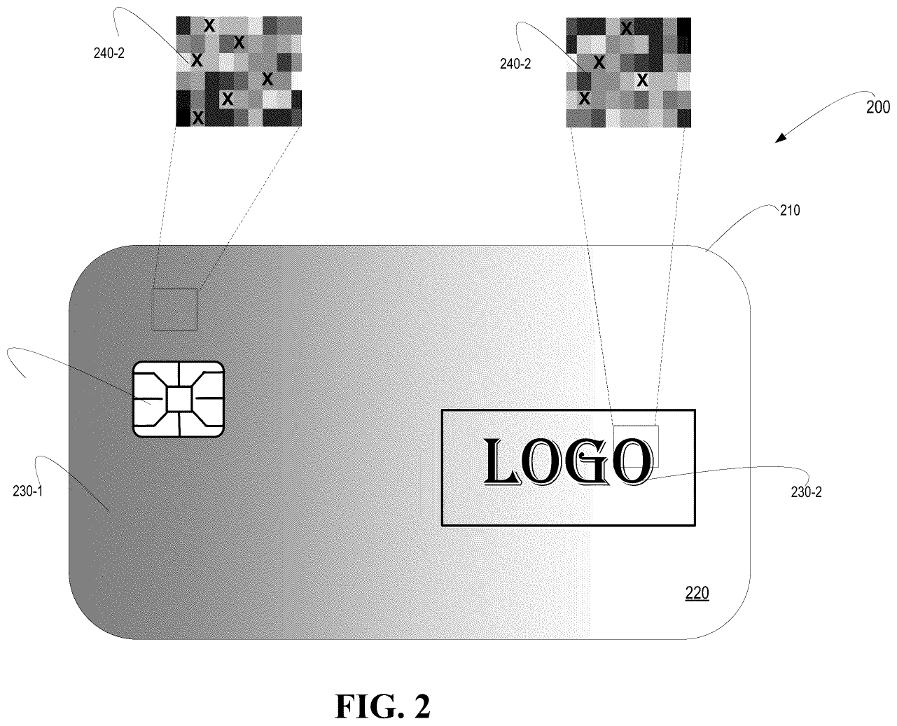

Referring to FIG. 2, a schematic diagram is presented of a resource exchange device 200, in accordance with embodiments of the present invention. Specifically, FIG. 2 illustrates a 2-dimensional representation of a front facing 220 of resource exchange device 200, which takes the form of a card 210, such as a payment card (e.g., debit card, credit card or the like). Resource exchange device 200 additionally includes a back facing 220 (not shown in FIG. 2) which may or may not include a magnetic stripe.

Front facing 220 includes one or more digital images 230 imprinted thereon. A shown in FIG. 2, front facing 220 includes background image 230-1, which encompasses an entirety of front facing 220 and a logo image 230-2, which may be positioned anywhere on front facing 220. Each of the digital images 230-1, 230-2 include a plurality of pixels 240. Separate areas of background image 230-1 and logo image 230-2 have been expanded to depict corresponding pixels 240-1 and 240-2. Specific pixels, marked with an “X” include a segment of the NFT identifier 310.

In this regard stenography techniques are implemented when the resource exchange device is generated to conceal the NFT identifier 310 within the pixels 240. Specifically, the pixel values are slightly modified or the least significant bits (LSBs) are altered to embed the NFT identifier within the pixels. The pixels 240 that include the encrypted data are commonly referred to as “stego-objects”. The embedding process may also entail determining which pixels 240 are to store segments of the NFT identifier 310 and the order/sequence by which segments of the NFT identifier 310 are stored in the selected pixels. The first resource exchange event authorization application 410 (shown in FIG. 1) includes the requisite algorithm(s) for decrypting the data, as well as keys required to reverse the embedding process (i.e., determine which pixels include data corresponding to segments of the NFT identifier 310 and the order/sequence in which the segments of the pixels 240 are required to be arranged to form the NFT identifier 310. In specific embodiments of the invention, the pixels 240 selected for storing segments of the NFT identifier 310 and the sequence/order in which the segments of the NFT identifier 310 are stored in the selected pixels 310 may be based on which digital images 230 are used to store the NFT identifier 310. While in other embodiments of the invention, the pixels 240 selected for storing segments of the NFT identifier 310 and the sequence/order in which the segments of the NFT identifier 310 are stored in the selected pixels 310 may be user 120-specific. In such embodiments of the invention, one or more other pixels 240 of the digital image(s) 230 may be configured to store data that identifies the user, so that subsequent algorithms used to reverse the embedding process are aware of which key(s) to use to unveil the NFT identifier (i.e., determine which pixels include segments of the NFT and the order/sequence for arranging the segments to result in the NFT).

In other specific embodiments of the invention, pixels 240 that do not include the NFT identifier or segments of the NFT identifier may include fake data, which is benign data that when decrypted resembles a segment of the NFT identifier but is not a segment of the NFT identifier. Fake data is used, in this instance, to further confuse a would-be wrongdoer who is attempting to discern the NFT identifier 310.

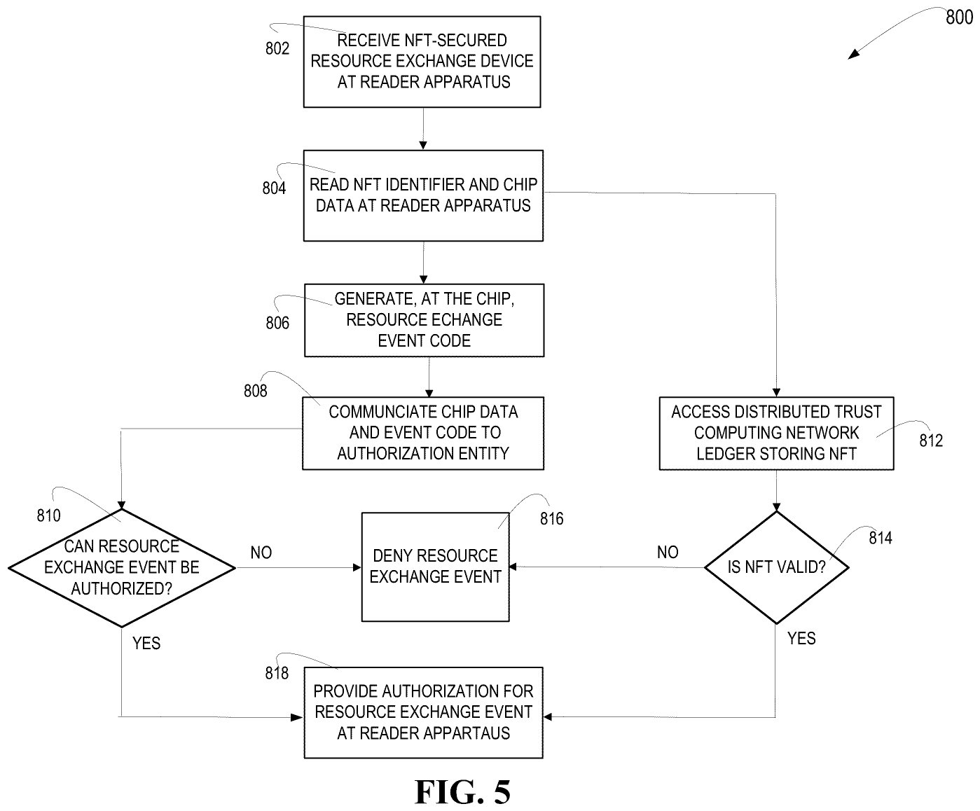

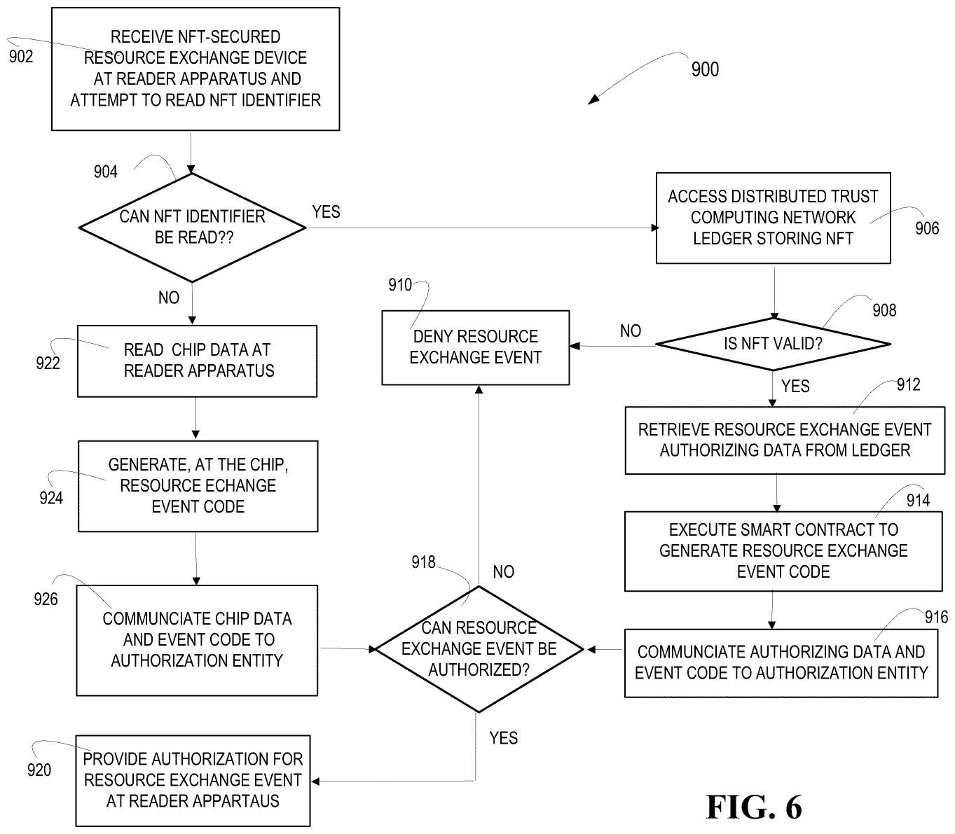

In specific embodiments of the invention, resource exchange device 200 includes embedded microprocessor chip 260, such as an EMV chip or the like. Embedded microprocessor chip may include memory which, in specific embodiments, stores data used in a second resource exchange event authorization process. The data may include user-identifying data, resource depository data and the like. Moreover, embedded microprocessor chip 260 may be capable of generating resource exchange event-specific codes, which along with at least a portion of the data stored on the embedded microprocessor chip 260 is communicated to a backend resource-exchange event authentication entity, such as a card-issuing entity or the like to determine whether the resource exchange event can be authorized. In specific embodiments of the invention, the NFT-based resource exchange event authorization process occurs in parallel with the microprocessor chip-based resource exchange event authorization process, such that approval/authorization must be provided by both authorization processes in order for the resource exchange event to be confirmed (See, discussion related to FIG. 5, infra.). In other specific embodiments of the invention, the microprocessor chip-based resource exchange event authorization process is used strictly as a back-up means for authentication, in the event that the NFT identifier is unable to read from the digital image(s) or some other step in the NFT-based resource exchange event authorization process is unable to be competed (See, discussion related to FIG. 6, infra.). In other embodiments of the invention, embedded microprocessor chip 260 may be configured to not store data used in any second resource exchange event authorization process, such user-identifying data, resource depository data and the like. In such embodiments of the invention, no second resource exchange event authorization process is performed, and the embedded microprocessor chip is merely included for purposes of confusing a would-be wrongdoer.

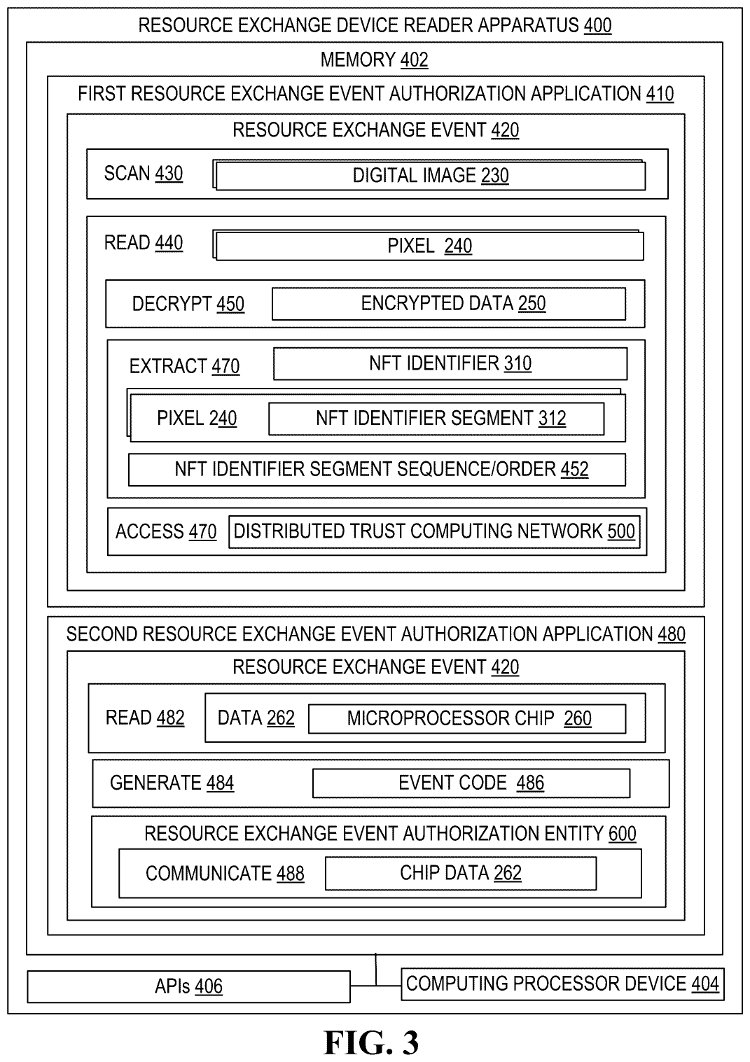

Referring to FIG. 3, a block diagram is presented of resource exchange device reader apparatus 400, in accordance with embodiments of the present invention. In addition to providing greater details of first authorization application 410, FIG. 3 highlights various alternate embodiments of the invention. Resource exchange device reader apparatus 400 may comprise one or multiple devices, such as a PoS device, an ATM device, as well as backend application servers, nodes in a distributed trust computing network and the like. Thus, according to specific embodiments of the invention, the functionality herein described of first resource exchange event authorization application 410 may occur exclusively at a PoS device, an ATM device or at both a PoS device/ATM device and back-end application server(s) and/or nodes within a distributed trust computing network.

Resource exchange device reader apparatus 400 includes memory 402, which may comprise volatile and/or non-volatile memory, such as read-only and/or random-access memory (RAM and ROM), EPROM, EEPROM, flash cards, or any memory common to computing platforms). Moreover, memory may comprise cloud storage, such as provided by a cloud storage service and/or a cloud connection service.

Further, computing platform 400 includes one or more computing processing devices 404, which may be an application-specific integrated circuit (“ASIC”), or other chipset, logic circuit, or other data processing device. Computing processing device(s) 404 may execute one or more application programming interface (APIs) 406 that interface with any resident programs, such as first authorization application 410, second authorization application 480 or the like, stored in memory 402 of resource exchange device reader apparatus 400 and any external programs. Resource exchange device reader apparatus 400 may include various processing subsystems (not shown in FIG. 3 embodied in hardware, firmware, software, and combinations thereof, that enable the functionality of resource exchange device reader apparatus 400 and the operability of resource exchange device reader apparatus 400 on a distributed communication network 110 (shown in FIG. 1), such as the Internet, intranet(s), cellular network(s) and the like. For example, processing subsystems allow for initiating and maintaining communications and exchanging data with other networked devices. For the disclosed aspects, processing subsystems of resource exchange device reader apparatus 400 may include any subsystem used in conjunction with first resource exchange event authorization application 410 and second resource exchange event authorization application 480 and related tools, routines, sub-routines, applications, sub-applications, sub-modules thereof.

In specific embodiments of the present invention, resource exchange device reader apparatus 400 additionally includes a communications module (not shown in FIG. 3) embodied in hardware, firmware, software, and combinations thereof, that enables electronic communications between components of resource exchange device reader apparatus 400 and other networks and network devices. Thus, communication module may include the requisite hardware, firmware, software and/or combinations thereof for establishing and maintaining a network communication connection with one or more devices and/or networks.

As discussed in FIG. 1, memory 402 of resource exchange device reader apparatus 400 stores first resource exchange event authorization application 410, which is executable by at least one of the one or more computing processor devices 404. As previously discussed in relation to FIG. 1, in response to user 120 (shown in FIG. 1) presenting resource exchange device 200 (shown in FIG. 1) at the resource exchange device reader apparatus 400 for initiating a resource exchange event 420, first resource exchange event authorization application 410 is configured to scan 430 the digital image(s) 230 to read 440 data stored in the plurality of pixels 240. Reading 440 the data includes applying requisite decryption algorithms to decrypt 450 the encrypted data 250 and extracting 460 the NFT identifier 310 from the decrypted data. Extracting 450 the NFT identifier 310 includes reversing the embedding process, which may include determining which pixels 240 include segments 312 of the NFT identifier 310 and the sequence/order 452 in which the segments 312 of the NFT identifier 310 need to be arranged in order to form the NFT identifier 310.

In response to extracting NFT identifier 310, first resource exchange event authorization application 410 is configured to use the NFT identifier 310 to access 470 the distributed trust computing network 500, which stores the NFT 300. Distributed trust computing network 500, commonly referred to as “block chain” network, includes a plurality of nodes 510 which store one or more distributed ledgers 520. According to embodiments of the present invention, each distributed ledger 520 stores within data blocks a corresponding NFT 300 and resource exchange event data. Once distributed trust computing network 300 is accessed, the NFT 300 is validated 530 and, in some embodiments of the system, authorization 540 is provided for the resource exchange event 420.

In specific embodiments of the invention, memory 402 of resource exchange device reader apparatus 400 additionally includes second resource exchange event authorization application 480. In response to user 120 (shown in FIG. 1) presenting resource exchange device 200 (shown in FIG. 1) at the resource exchange device reader apparatus 400 for initiating a resource exchange event 420 or in response to notification that the first resource exchange event authentication application 410 has failed, second resource exchange event authorization application 480 is configured to read 482 the data 262 stored on an embedded microprocessor chip 260, such as an EMV chip in the resource exchange device 200. The data may include user-identifying data and resource depository data (e.g., account number) and the like. In addition, second resource exchange event authorization application 480 may be configured to generate 484 a resource exchange event code 486, unique to the event/transaction and, subsequently, communicate 488 the chip data 262 and the event code 486 to a resource exchange event authorization entity 600. In turn, the resource exchange event authorization entity 600 will validate the chip data 262 as a means for authorizing the resource exchange event 420.

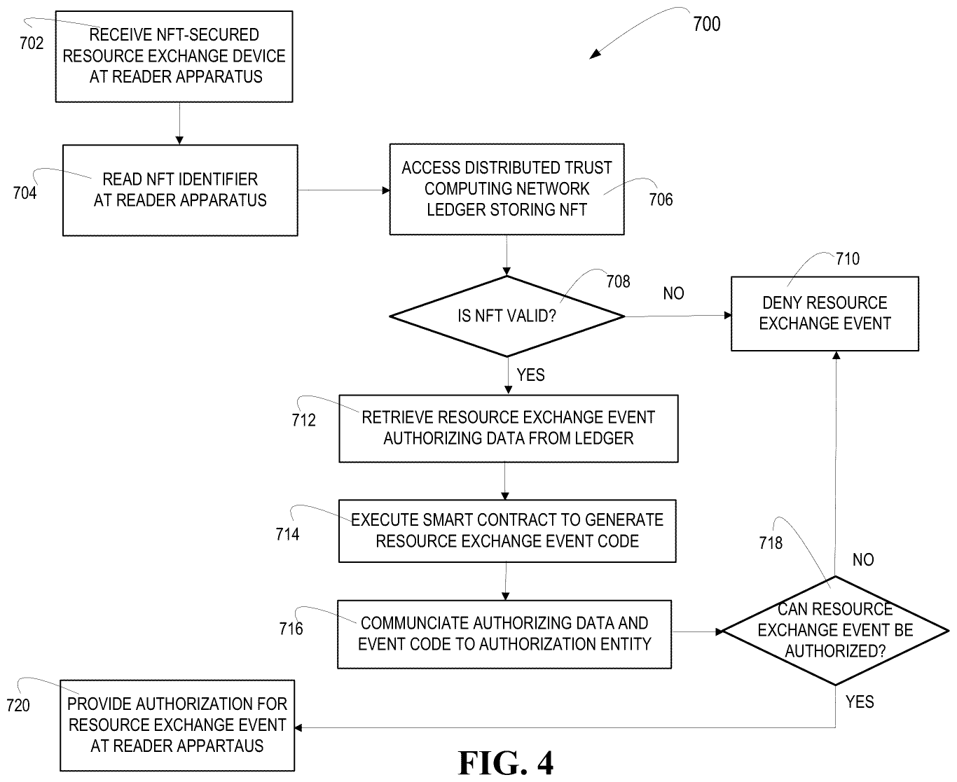

Referring to FIG. 4, a flow diagram is depicted of a method 700 for resource exchange event authorization, in accordance with embodiments of the present invention. In the method described in relation to FIG. 4 resource exchange event authorization is based solely on the NFT. At Event 702, an NFT-secured resource exchange device, such as a payment card is received at a resource exchange device reader apparatus, such as a PoS terminal and ATM or the like. At Event 704, the NFT identifier is read at the reader apparatus. As previously discussed, reading of the NFT identifier entails scanning the images imprinted on the device/card, reading data stored in pixels, decrypting the data and extracting the NFT identifier from the decrypted data.

In response to extracting the NFT identifier, at Event 706, a distributed trust computing network is accessed, specifically the distributed ledger that stores the NFT is accessed. At Decision 708, a determination is made as to the NFTs validity. Such validation may be accomplished by ensuring that the NFT exists on the ledger of the distributed trust computing network and/or smart contract verification, and/or consensus amongst nodes or the like. If the NFT is determined not to valid, at Event 710, the resource exchange event is denied confirmation and a notification saying such may be communicated to the user via the resource exchange event reader apparatus.

If the NFT is determined to be valid, at Event 712, resource exchange event authorizing data, such as user-identifying data and resource depository/account data is retrieved from the distributed ledger and, at Event 714 a smart contract is executed to generate a resource exchange event code (i.e., a unique transaction code) for the event. At Event 716, the authorizing data and the resource exchange event code are communicated to an authorizing entity, such as a resource exchange device issuing-entity (e.g., card-issuer) or the like.

In response to receiving the authorizing data and the resource exchange event code, at Decision 718, the authorizing entity determines whether the resource exchange event can be authorized. If the resource exchange event cannot be authorized, at Event 710, the resource exchange event is denied confirmation and a notification saying such may be communicated to the user via the resource exchange event reader apparatus. If the resource exchange event is authorized, at Event 720, notification of authorization for the resource exchange event is provided to the user via the resource change device reader apparatus and the resource exchange event is deemed to be confirmed.

Referring to FIG. 5, a flow diagram is depicted of a method 700 for resource exchange event authorization, in accordance with embodiments of the present invention. In the method described in relation to FIG. 5 resource exchange event authorization is based on NFT validation and microprocessor chip-based resource exchange event authorization. At Event 802, an NFT-secured resource exchange device, such as a payment card is received at a resource exchange device reader apparatus, such as a PoS terminal, an ATM or the like. At Event 804, the NFT identifier and embedded microprocessor chip data is read at the reader apparatus. As previously discussed, reading of the NFT identifier entails scanning the images imprinted on the device/card, reading data stored in pixels, decrypting the data and extracting the NFT identifier from the decrypted data. At Event 806, the microprocessor chip generates a resource exchange event code, such as a unique transaction code. At Event 808, the chip data and the resource exchange event code are communicated to an authorization entity such as a resource exchange device issuing-entity (e.g., card-issuer) or the like.

In response to receiving the authorizing data and the resource exchange event code, at Decision 810, the authorizing entity determines whether the resource exchange event can be authorized. Once the NFT identifier has been read and in parallel with Events 806 and 808, at Event 812, a distributed trust a distributed trust computing network is accessed, specifically the distributed ledger that stores the NFT is accessed. At Decision 814, a determination is made as to the NFTs validity. If the resource exchange event cannot be authorized or the NFT is determined to be invalid, at Event 816, the resource exchange event is denied confirmation and a notification saying such may be communicated to the user via the resource exchange event reader apparatus.

If the resource exchange event is authorized and the NFT is determined to be valid, at Event 818, notification of authorization for the resource exchange event is provided to the user via the resource change device reader apparatus and the resource exchange event is deemed to be confirmed.

Referring to FIG. 6, a flow diagram is depicted of a 900 for resource exchange event authorization, in accordance with embodiments of the present invention. In the method described in relation to FIG. 6 resource exchange event authorization is based on NFT validation and, if the NFT validation fails, then the authorization is based on microprocessor chip-based resource exchange event authorization. At Event 902, an NFT-secured resource exchange device, such as a payment card is received at a resource exchange device reader apparatus, such as a PoS terminal, an ATM or the like and attempt to read the NFT identifier is made. At Decision 904, a determination is made as to whether the NFT identifier was properly read.

If the NFT was properly read, at Event 906, a distributed trust computing network is accessed, specifically the distributed ledger that stores the NFT is accessed. At Decision 908, a determination is made as to the NFTs validity. Such validation may be accomplished by ensuring that the NFT exists on the ledger of the distributed trust computing network and/or smart contract verification, and/or consensus amongst nodes or the like. If the NFT is determined not to be valid, at Event 910, the resource exchange event is denied confirmation and a notification saying such may be communicated to the user via the resource exchange event reader apparatus.

If the NFT is determined to be valid, at Event 912, resource exchange event authorizing data, such as user-identifying data and resource depository/account data is retrieved from the distributed ledger and, at Event 914 a smart contract is executed to generate a resource exchange event code (i.e., a unique transaction code) for the event. At Event 916, authorizing data and the resource exchange event code are communicated to an authorizing entity, such as a resource exchange device issuing-entity (e.g., card-issuer) or the like. At Decision 918, a determination is made as to whether the resource exchange event can be authorized. If the resource exchange event cannot be authorized, at Event 910, the resource exchange event is denied and notification stating such may be communicated to the user via the resource exchange event reader apparatus.

If the resource exchange event can be authorized, At Event 920, a notification of authorization for the resource exchange event is provided to the user via the resource change device reader apparatus and the resource exchange event is deemed to be confirmed.

If the NFT cannot be read properly, at Event 922, data is read from an embedded microprocessor chip in the resource exchange device and, at Event 924, a resource exchange event code (e.g., unique transaction code) is generated by the microprocessor chip. At Event, 926, the chip data and the resource exchange event code are communicated to the authorization entity and, at Decision 918, a determination is made as to whether the resource exchange event can be authorized. If the resource exchange event cannot be authorized, at Event 910, the resource exchange event is denied and notification stating such may be communicated to the user via the resource exchange event reader apparatus.

If the resource exchange event can be authorized, At Event 920, a notification of authorization for the resource exchange event is provided to the user via the resource change device reader apparatus and the resource exchange event is deemed to be confirmed.

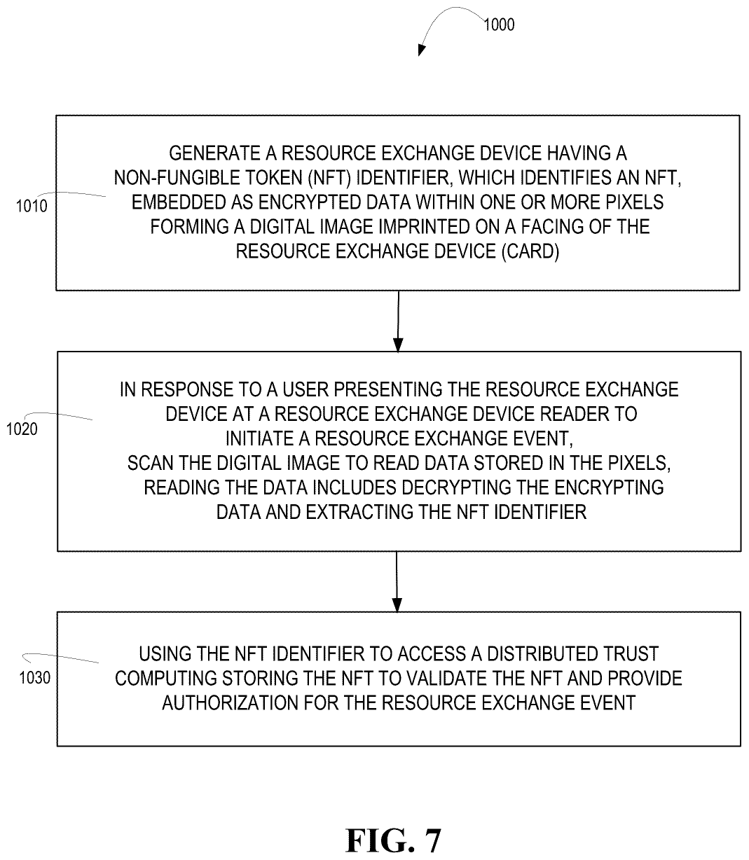

Referring to FIG. 7, a flow diagram is presented of a method 100 for authorizing a resource exchange event, in accordance with embodiments of the present invention. At Event 1010, a resource exchange device is generated that has an NFT identifier embedded as encrypted data within one or more pixels forming a digital image that is imprinted on a facing of the carded resource exchange device. The NFT identifier may be embedded within the pixels using conventional stenographic techniques or the like, in which the pixel value is modified or the least significant bits (LSBs) are altered as a means of adding data to the pixels.

In response to a user presenting the resource exchange device at a resource exchange device reader apparatus to initiate a resource exchange event, at Event 1020, the digital image is scanned to read data stored within the pixels. As previously discussed, reading the data includes decrypting encrypted data and extracting the NFT identifier from the decrypted data (i.e., applying keys that are configured to undue stenography techniques used to conceal the NFT identifier). In specific embodiments of the method, in which the NFT identifier has been segmented and each segmented stored in a different pixel of the digital image, the extraction process may include determining which pixels store the segments of the NFT identifier and determining the order/sequence for arranging the segments to form the NFT identifier.

Once the NFT identifier has been extracted, at Event 1030, a distributed trust computing network, at which the NFT is stored, is accessed for purposes of validating the NFT and, in some embodiments of the invention, authorizing the resource exchange event.

Thus, present embodiments of the invention discussed in detail above, provide for validation of a resource exchange device and/or authorization of a resource exchange event being conducted with the resource exchange device through use of a Non-Fungible Token (NFT) that is accessible via an NFT identifier encrypted and embedded within a digital image imprinted on the resource exchange device. In specific embodiments of the invention different segments of the NFT identifier are stored in different predetermined pixels of the digital image as a means of further obfuscating the NFT identifier. Once the resource exchange device is presented at a corresponding reader apparatus, the digital image is scanned to read the data stored within the digital image, decrypt the data and extract the NFT identifier from the data. In those embodiments in which the NFT identifier is segmented and stored in preselected pixels, the extraction process entails determining which pixels store the segments of the NFT identifier and the sequence/order of the segments required to form the NFT identifier. Once the NFT identifier has been extracted, the corresponding distributed trust computing network, which stores the NFT, is accessed for purposes of validating the authenticity of the NFT (i.e., the resource exchange device) and authorizing the resource exchange event.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for resource exchange event authorization, the system comprising:
a resource exchange device configured in a form of a card having two facings, wherein at least one facing has a digital image imprinted thereon, wherein the digital image comprises a plurality of pixels and wherein a Non-Fungible Token (NFT) identifier that identifies an NFT is embedded as encrypted data within one or more of the plurality of pixels; and
a resource exchange device reader apparatus including a memory and one or more computing processor devices in communication with the memory, wherein the memory stores a first resource exchange event authorization application, wherein the resource exchange event authorization application is executable by at least one of the computing device processors and is configured to:
in response to a user presenting the resource exchange device at the resource exchange device reader to initiate a resource exchange event, scan the digital image to read data stored in the plurality of pixels, wherein reading the data includes decrypting the encrypting data and extracting the NFT identifier, and
use the NFT identifier to access a distributed trust computing storing the NFT to validate the NFT and provide first authorization for the resource exchange event.

2. The system of claim 1, wherein the digital image comprises at least one selected from the group consisting of (i) a background image imprinted on the at least one facing of the card, and (ii) a logo image imprinted on the at least one facing of the card.

3. The system of claim 1, wherein segments of the NFT identifier are embedded in two or more first pixels from amongst the plurality of pixels, and wherein the segments are configured to form an entirety of the NFT identifier.

4. The system of claim 3, wherein the resource exchange event authorization application is further configured to extract the NFT identifier by determining which of the plurality of pixels are the selected first pixels having embedded segments of the NFT identifier.

5. The system of claim 4, wherein the resource exchange event authorization application is further configured to extract the NFT identifier by determining a sequence in which the segments of the NFT identifier are to be configured to form the NFT identifier.

6. The system of claim 3, wherein fake data is embedded within one or more second pixels from amongst the plurality of pixels, wherein the second pixels are different than the first pixels and wherein the fake data is configured to resemble a segment of the NFT identifier.

7. The system of claim 1, wherein the resource exchange device further comprises an embedded microprocessor chip.

8. The system of claim 7, wherein the memory of the resource exchange device reader further stores a second resource exchange event authorization application that is configured to:
in response to the user presenting the resource exchange device at the resource exchange device reader to initiate the resource exchange event, read data stored on the embedded microprocessor chip and communicate at least a portion of the data to a resource exchange event authorization entity configured to validate the portion of the data and provide second authorization for the resource exchange event,
wherein both the first authorization and the second authorization are required to finalize the resource exchange event.

9. The system of claim 7, wherein the first resource exchange event authorization application is further configured to:
in response to the user presenting the resource exchange device at the resource exchange device reader to initiate the resource exchange event, determine that data stored in the pixels is unable to be read, and
wherein the memory of the resource exchange device reader further stores a second resource exchange event authorization application that is configured to:
in response to receiving notification that data stored in the pixels is unable to be read, read data stored on the embedded microprocessor chip and communicate at least a portion of the data to a resource exchange event authorization entity configured to validate the portion of the data and provide second authorization for the resource exchange event.

10. The system of claim 7, wherein the embedded microprocessor chip does not store any user identifying data or resource exchange depository identifying data.

11. A device for resource exchange event authorization, the device comprising:
a body formed of a card having two facings;
a digital image imprinted on at least one of the facings and comprising a plurality of pixels; and
a Non-Fungible Token (NFT) identifier that identifies an NFT and is embedded as encrypted data within one or more of the plurality of pixels, wherein the NFT identifier is configured to provide access to a distributed trust computing network storing the NFT for validating the NFT and providing first authorization for a resource exchange event.

12. The device of claim 11, wherein the digital image comprises at least one selected from the group consisting of (i) a background image imprinted on the at least one facing of the card, and (ii) a logo image imprinted on the at least one facing of the card.

13. The device of claim 11, wherein segments of the NFT identifier are embedded within two or more first pixels from amongst the plurality of pixels, and wherein the segments are configured to form an entirety of the NFT identifier.

14. The device of claim 13, wherein fake data is embedded within one or more second pixels from amongst the plurality of pixels, wherein the second pixels are different than the first pixels and wherein the fake data is configured to resemble a segment of the NFT identifier.

15. The device of claim 11, further comprising a microprocessor chip embedded within the body, wherein the microprocessor chip stores data that is configured to be validated by a resource exchange event authorization entity to provide second authorization for the resource exchange event,
wherein both the first authorization and the second authorization are required to finalize the resource exchange event.

16. A computer-implemented method for authorizing a resource exchange event, the method being executable by one or more computing device processors and comprising:
generating a resource exchange device having a Non-Fungible Token (NFT) identifier that identifies an NFT embedded as encrypted data within one or more of a plurality of pixels forming a digital image imprinted on a facing of the resource exchange device;
in response to a user presenting the resource exchange device at a resource exchange device reader to initiate a resource exchange event, scanning the digital image to read data stored in the plurality of pixels, wherein reading the data includes decrypting the encrypting data and extracting the NFT identifier, and
using the NFT identifier to access a distributed trust computing storing the NFT to validate the NFT and provide first authorization for the resource exchange event.

17. The computer-implemented method of claim 16, wherein generating the resource exchange device further comprises embedding segments of the NFT identifier in two or more pixels from amongst the plurality of pixels, and wherein the segments are configured to form an entirety of the NFT identifier.

18. The computer-implemented method of claim 17, wherein extracting the NFT identifier further comprises determining which of the plurality of pixels are the selected first pixels having embedded segments of the NFT identifier.

19. The computer-implemented method of claim 17, wherein extracting the NFT identifier further comprises determining a sequence in which the segments of the NFT identifier are to be configured to form the NFT identifier.

20. The computer-implemented method of claim 16, wherein generating the resource exchange device further comprises generating the resource exchange device having a microprocessor chip embedded therein, and
further comprising:
in response to the user presenting the resource exchange device at the resource exchange device reader to initiate the resource exchange event, reading data stored on the embedded microprocessor chip and communicating at least a portion of the data to a resource exchange event authorization entity configured to validate the portion of the data and provide second authorization for the resource exchange event,
wherein both the first authorization and the second authorization are required to finalize the resource exchange event.
